(19) United States
(12) Patent Application Publication
(10) Pub. No.: US 2026/0038966 A1
(43) Pub. Date: Feb. 5, 2026

(54) SEPARATOR FOR NON-AQUEOUS ELECTROLYTE BATTERY, AND NON-AQUEOUS ELECTROLYTE BATTERY

(71) Applicant: Mazda Motor Corporation, Aki-gun (JP)

(72) Inventors: Yuta Fukushima, Aki-gun (JP); Takanori Kajimoto, Aki-gun (JP)

(21) Appl. No.: 19/256,410

(22) Filed: Jul. 1, 2025

(30) Foreign Application Priority Data
Jul. 31, 2024 (JP) 2024-124296

(51) Int. Cl. H01M 50/449; H01M 4/48; H01M 10/0525; H01M 10/0585; H01M 50/417; H01M 50/423

(52) U.S. Cl. CPC H01M 50/449; H01M 4/48; H01M 10/0525; H01M 10/0585; H01M 50/417; H01M 50/423

(57) ABSTRACT

For preventing detachment of a separator of a non-aqueous electrolyte battery from a silicon-based negative electrode of the battery, the separator includes a first layer that is in contact with the silicon-based negative electrode, and a second layer that is in contact with the first layer and is interposed between the silicon-based negative electrode and a positive electrode. The second layer has a higher elastic modulus than the first layer.

### TECHNICAL FIELD

The technology disclosed herein relates to a separator for a non-aqueous electrolyte battery, and a non-aqueous electrolyte battery.

### BACKGROUND ART

A conventional separator for a non-aqueous electrolyte battery is disclosed in WO2021/187607A1. The conventional separator includes a substrate, and a particle layer on a main surface of the substrate. The particle layer has a protruding pattern. When a negative electrode expands with charging of the non-aqueous electrolyte battery, the particle layer presses the separator, a positive electrode, and the negative electrode to prevent displacement in the structure of an electrode stack.

### SUMMARY

### Technical Problem

A silicon-based negative electrode enables a non-aqueous electrolyte battery to have high capacity. However, a silicon-based negative electrode significantly expands and contracts with charging and discharging. There is a risk that the separator in contact with the silicon-based negative electrode cannot follow the significant expansion and contraction of the silicon-based negative electrode, and the separator may detach from the silicon-based negative electrode. The detachment of the separator may cause an internal short circuit in the non-aqueous electrolyte battery.

The technology disclosed herein prevents the separator of a non-aqueous electrolyte battery including a silicon-based negative electrode from detaching from the negative electrode.

### Solution to Problem

A separator with a low elastic modulus can follow significant expansion and contraction of a silicon-based negative electrode and can prevent detachment of the separator from the silicon-based negative electrode. However, it is difficult for a separator with a low elastic modulus to ensure the strength required for the separator.

In order to ensure the strength of the separator, it is conceivable to provide the separator with a coating. An example of the coating is aluminum oxide (alumina). However, since such a coating has a relatively high electric resistance, the coating adversely affects the characteristics of the non-aqueous electrolyte battery.

Therefore, the inventors of the present application have made a separator which is in contact with a silicon-based negative electrode as a two-layer separator made of two kinds of materials with different clastic moduli.

Specifically, the technology disclosed herein relates to a separator for a non-aqueous electrolyte battery. This separator includes a first layer that is in contact with a silicon-based negative electrode of the battery, and a second layer that is in contact with the first layer and is interposed between the silicon-based negative electrode and a positive electrode of the battery, the second layer having a higher elastic modulus than the first layer.

The first layer of the separator is in contact with the silicon-based negative electrode. The first layer has a relatively low elastic modulus. Here, the low clastic modulus may be rephrased to mean that the Young's modulus of the material constituting the first layer is low. The first layer is relatively soft. Even when the silicon-based negative electrode significantly expands and contracts with charging and discharging of the non-aqueous electrolyte battery, the first layer can follow the expansion and contraction of the silicon-based negative electrode. The first layer is therefore prevented from detaching from the silicon-based negative electrode.

The separator includes a second layer. The second layer is in contact with the first layer. More specifically, the second layer is interposed between the silicon-based negative electrode and the positive electrode. The second layer has a relatively high clastic modulus. The high elastic modulus may be rephrased to mean that the Young's modulus of the material constituting the second layer is high. The second layer has a relatively high rigidity and more easily ensures strength than the first layer.

The separator including the soft first layer and the high-strength second layer can ensure the strength required for the separator of the non-aqueous electrolyte battery while preventing detachment of the separator from the silicon-based negative electrode. Since the soft first layer is combined with the high-strength second layer, it is possible to ensure the strength of the separator without increasing the thickness of the entire separator. Reducing the thickness of the separator is advantageous in increasing the capacity of the non-aqueous electrolyte battery.

The first layer may be polypropylene (PP).

The first layer may also be polyamide (PA).

Polypropylene (PP) or polyamide (PA) can prevent detachment from the silicon-based negative electrode.

The second layer may be polyethylene terephthalate (PET).

The second layer may also be polystyrene (PS).

Polyethylene terephthalate (PET) or polystyrene (PS) can ensure the strength required for the separator of the non-aqueous electrolyte battery, with a combination of polypropylene (PP) or polyamide (PA) as the first layer.

The silicon-based negative electrode may contain silicon monoxide (SiO), and the positive electrode may contain lithium (Li).

A combination of the negative electrode containing silicon monoxide (SiO) and the positive electrode containing lithium (Li) is advantageous in increasing the capacity of the non-aqueous electrolyte battery. On the other hand, the negative electrode containing silicon monoxide (SiO) significantly expands and contracts with charging and discharging of the non-aqueous electrolyte battery. In the non-aqueous electrolyte battery with the negative electrode containing silicon monoxide (SiO), the separator including the first layer and the second layer can prevent detachment from the negative electrode and ensure strength.

A non-aqueous electrolyte battery disclosed herein includes the separator, and the silicon-based negative electrode and the positive electrode separated by the separator.

This non-aqueous electrolyte battery can achieve high capacity.

The positive electrode may be in contact with the second layer.

In other words, although the separator is interposed between the positive electrode and

the silicon-based negative electrode, the separator including the first layer and the second layer can prevent the expansion and contraction of the silicon-based negative electrode from affecting the positive electrode.

The separator may include a third layer that is interposed between the second layer and the positive electrode.

The second layer of the separator may not be in direct contact with the positive electrode. The third layer may be a layer having a specific function. An example of the specific function is a thermal resistance function.

### Advantageous Effects

According to the separator for a non-aqueous electrolyte battery and the non-aqueous electrolyte battery outlined above, detachment of the separator from the silicon-based negative electrode can be prevented.

### BRIEF DESCRIPTION OF DRAWINGS

FIG. 1 is a cross-sectional view of a non-aqueous electrolyte battery.

FIG. 2 is a partially enlarged view of the non-aqueous electrolyte battery.

FIG. 3 shows the properties of materials that can be used for a first layer and a second layer of a separator.

FIG. 4 is a partially enlarged view of a non-aqueous electrolyte battery according to a modified example.

### DETAILED DESCRIPTION

An embodiment a non-aqueous electrolyte battery and a separator thereof will be described below with reference to the drawings. The separator and the non-aqueous electrolyte battery described herein are exemplary.

### Overall Structure of Secondary Battery

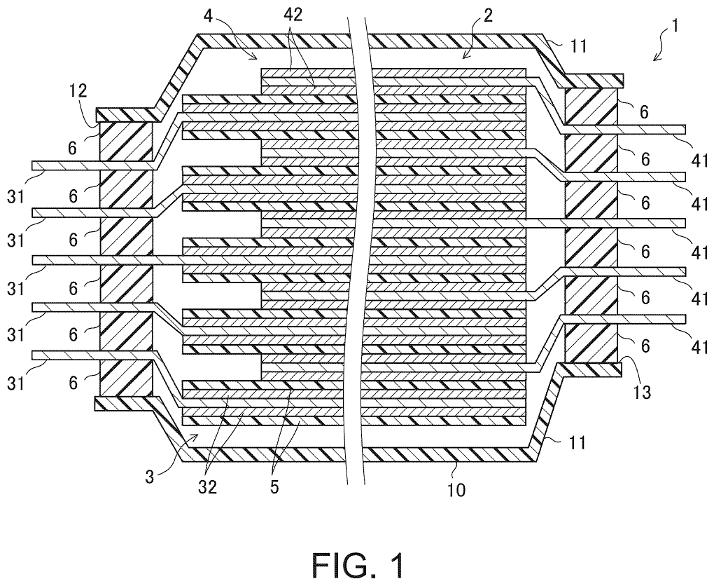

FIG. 1 schematically shows an overall structure of a non-aqueous electrolyte battery 1. The non-aqueous electrolyte battery 1 of FIG. 1 is a battery cell having an electricity generation element 2 accommodated in a container 10. For example, the non-aqueous electrolyte battery 1 is a lithium-ion battery. The container 10 is formed by folding a sheet of laminate material 11 or by stacking two sheets of laminate material 11 into the shape of a bag. For example, the laminate material 11 has a three-layer structure including a metal layer interposed between resin layers. The metal layer is, for example, aluminum or stainless steel. The resin layers are, for example, polypropylene (PP) or polyethylene (PE). The container 10 is sealed, with the electricity generation element 2 and an electrolyte contained in the container 10. The non-aqueous electrolyte battery 1 is a so-called pouch-type battery. Note that the non-aqueous electrolyte battery to which the separator disclosed herein is applicable is not limited to a pouch type.

The electricity generation element 2 includes a negative electrode 3 and a positive electrode 4. The negative electrode 3 and the positive electrode 4 are immersed in the electrolyte in the container 10. The negative electrodes 3 and the positive electrodes 4 are alternately stacked. The numbers of the negative electrodes 3 and the positive electrodes 4 are arbitrary. The number of the negative electrodes 3 and that of the positive electrodes 4 may be such that the number of the negative electrodes 3 is larger, for example. The electricity generation element 2 is an electrode stack. Note that the direction in which the negative electrodes 3 and the positive electrodes 4 are stacked may be hereinafter called the “stacking direction.”

The negative electrode 3 has a negative electrode current collector 31. The negative electrode current collector 31 is a plate material having a small thickness and extending in a direction orthogonal to the stacking direction. A first end portion of the negative electrode current collector 31, that is, the left end portion in FIG. 1, projects outward from a first opening 12 of the container 10.

A negative electrode active material is applied to a first surface and a second surface of the negative electrode current collector 31 positioned inside the container 10. The first surface is an upper surface of the negative electrode current collector 31 in FIG. 1, and the second surface is a lower surface of the negative electrode current collector 31 in FIG. 1. The negative electrode active material forms a negative electrode composite material 32 on the negative electrode current collector 31. The negative electrode 3 includes the negative electrode current collector 31 and the negative electrode composite material 32.

The negative electrode 3 is a silicon-based negative electrode. In other words, the negative electrode active material contains silicon. Here, the negative electrode active material contains silicon monoxide (SiO). The silicon-based negative electrode is advantageous in increasing the capacity of the non-aqueous electrolyte battery 1.

The negative electrode 3 has a separator 5. The separator 5 is interposed between the negative electrode 3 and the positive electrode 4. The separator 5 separates the negative electrode composite material 32 of the negative electrode 3 from a positive electrode composite material 42 of the positive electrode 4. The separator 5 is, for example, a porous material allowing passage of ionic substances. The separator 5 covers at least a main surface of the negative electrode composite material 32 of the negative electrode 3. The details of the structure of the separator 5 will be described later.

The positive electrode 4 has a positive electrode current collector 41. The positive electrode current collector 41 is a plate material having a thin thickness and extending in a direction orthogonal to the stacking direction. A second end portion of the positive electrode current collector 41, that is, the right end portion in FIG. 1, projects outward from a second opening 13 of the container 10. The second opening 13 is an opening on the opposite side to the first opening 12 in the direction orthogonal to the stacking direction. Note that the projecting direction of the positive electrode current collector 41 is not limited to the opposite side with respect to the negative electrode current collector 31.

A positive electrode active material is applied to a first surface and a second surface of the positive electrode current collector 41 positioned inside the container 10. The positive electrode active material forms a positive electrode composite material 42 to which the positive electrode current collector 41 is connected. The positive electrode active material is a metal oxide containing lithium (Li). The positive electrode 4 includes the positive electrode current collector 41 and the positive electrode composite material 42.

As described above, the negative electrodes 3 and the positive electrodes 4 are alternately stacked. The negative electrode composite material 32 and the positive electrode composite material 42 are stacked with the separator 5 interposed therebetween in the stacking direction inside the container 10. For example, the area of the negative electrode composite material 32 may be larger than the area of the positive electrode composite material 42.

The first opening 12 of the container 10 is sealed with a resin 6. The resin 6 is positioned between a laminate material 11 and the negative electrode current collector 31, and between the negative electrode current collectors 31. Similarly, the second opening 13 is sealed with the resin 6. The resin 6 is positioned between the laminate material 11 and the positive electrode current collector 41, and between the positive electrode current collectors 41.

A plurality of negative electrode current collectors 31 individually project to the outside of the container 10, without being connected inside the container 10. Similarly, a plurality of positive electrode current collectors 41 individually project to the outside of the container 10, without being connected inside the container 10. Since connection space for the negative electrode current collectors 31 and the positive electrode current collectors 41 can be saved in the container 10, the areas of the negative electrode composite material 32 and the positive electrode composite material 42 can be correspondingly increased. Therefore, the energy density of the non-aqueous electrolyte battery I can be increased.

Note that the above-described structure of the non-aqueous electrolyte battery 1 is an example. The non-aqueous electrolyte battery to which the separator disclosed herein is applicable is not limited to the above-described structure.

### Structure of Separator

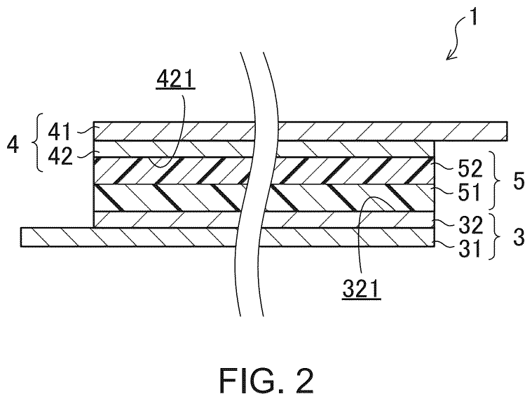

Next, the structure of the separator 5 will be described in detail with reference to FIG. 2. FIG. 2 shows a cross-section of one negative electrode 3, one separator 5, and one positive electrode 4 included in the electricity generation element 2.

The separator 5 includes a first layer 51. The first layer 51 is in contact with the negative electrode 3, more precisely a main surface 321 of the negative electrode composite material 32. The main surface 321 of the negative electrode composite material 32 is a surface that faces the positive electrode composite material 42 with the separator 5 therebetween.

The separator 5 includes a second layer 52. The second layer 52 is a layer that is in contact with the first layer 51 in the stacking direction. The separator 5 has a two-layer structure including the first layer 51 and the second layer 52. The second layer 52 is interposed between the negative electrode 3 and the positive electrode 4. The positive electrode 4, more precisely a main surface 421 of the positive electrode composite material 42 is in contact with the second layer 52. The main surface 421 of the positive electrode composite material 42 is a surface that faces the negative electrode composite material 32 with the separator 5 therebetween.

The first layer 51 and the second layer 52 are made of materials having different properties. The second layer 52 has a higher elastic modulus than the first layer 51. In other words, the Young's modulus of the second layer 52 is higher than that of the first layer 51.

The first layer 51 may be polyolefin, more specifically polypropylene (PP). The first layer 51 may also be polyamide (PA), that is, nylon. The elastic modulus of the first layer 51 is relatively low. In the separator 5, the first layer 51 is relatively soft.

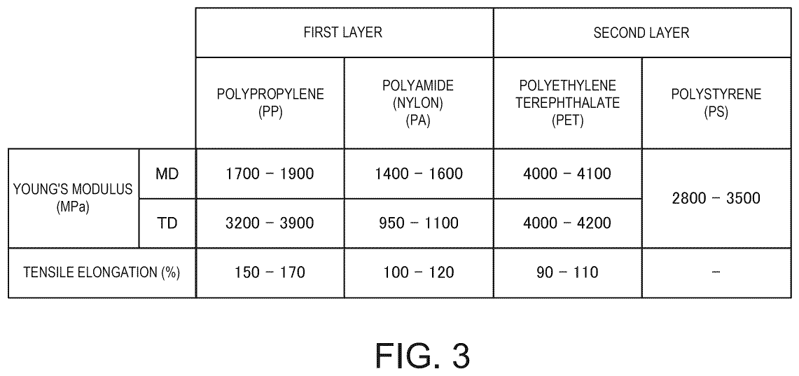

The second layer 52 may be polyester, more specifically polyethylene terephthalate (PET). The second layer 52 may also be polystyrene (PS). The elastic modulus of the second layer 52 is relatively high. In the separator 5, the second layer 52 is relatively hard. FIG. 3 shows the properties of materials that can be used for the first layer 51 and the second layer 52. While the second layer 52 has a relatively high Young's modulus, the second layer 52 can ensure high strength. Note that materials that can be used for the first layer 51 and the second layer 52 are not limited to the materials shown in FIG. 3.

The negative electrode 3 of the non-aqueous electrolyte battery 1 is a silicon-based negative electrode, and the negative electrode 3 significantly expands and contracts with charging and discharging of the non-aqueous electrolyte battery 1. The first layer 51 in contact with the negative electrode 3 has a low elastic modulus and is soft; thus, even when the negative electrode 3 significantly expands and contracts, the first layer 51 can follow the expansion and contraction of the negative electrode 3. The first layer 51 is prevented from detaching from the negative electrode 3.

Since the second layer 52 can ensure strength more easily than the first layer 51, the separator 5 including the first layer 51 and the second layer 52 can ensure the strength required for the separator 5 of the non-aqueous electrolyte battery 1. The separator 5 including the first layer 51 and the second layer 52 can prevent the expansion and contraction of the negative electrode 3 from affecting the positive electrode 4.

Moreover, the separator 5 including the first layer 51 and the second layer 52 can ensure the necessary strength of the separator without increasing the thickness of the entire separator 5. Reducing the thickness of the separator 5 is advantageous in increasing the energy density of the non-aqueous electrolyte battery 1 and increasing the capacity of the non-aqueous electrolyte battery 1. Note that the thickness of the first layer 51 and the thickness of the second layer 52 can be appropriate thicknesses.

Furthermore, a combination of a material used for the first layer 51 and a material used for the second layer 52 can be arbitrarily selected from the materials mentioned as examples above. Note that the combination of the material used for the first layer 51 and the material used for the second layer 52 may be made so that the difference between the Young's modulus of the first layer 51 and the Young's modulus of the second layer 52 will not be too large. This is because if the difference between the Young's modulus of the first layer 51 and the Young's modulus of the second layer 52 is too large, there is a risk that detachment may occur between the first layer 51 and the second layer 52.

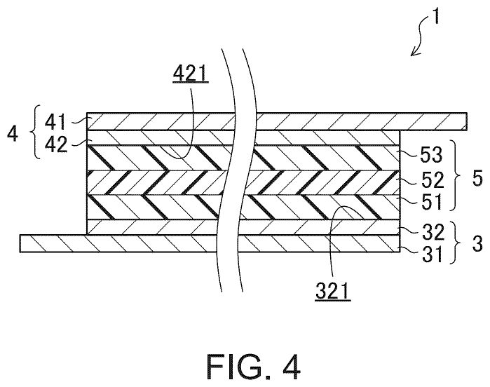

Note that, as a modified example of the non-aqueous electrolyte battery 1, the second layer 52 of the separator 5 and the positive electrode 4 are not necessarily in direct contact with each other. As shown in FIG. 4, the separator 5 may include a third layer 53 that is interposed between the second layer 52 and the positive electrode 4. The third layer 53 may be a layer having a thermal resistance function, for example. The third layer with the thermal resistance function may be, for example, aramid. Note that the function provided by the third layer 53 is not limited to the thermal resistance function.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1 non-aqueous electrolyte battery
3 silicon-based negative electrode
4 positive electrode
5 separator
51 first layer
52 second layer
53 third layer

1. A separator for a non-aqueous electrolyte battery, the separator comprising:
a first layer that is in contact with a silicon-based negative electrode of the battery; and
a second layer that is in contact with the first layer and is interposed between the silicon-based negative electrode and a positive electrode of the battery, the second layer having a higher elastic modulus than the first layer.

2. The separator according to claim 1, wherein the first layer is polypropylene (PP).

3. The separator according to claim 1, wherein the first layer is polyamide (PA).

4. The separator according to claim 1, wherein the second layer is polyethylene terephthalate (PET).

5. The separator according to claim 1, wherein the second layer is polystyrene (PS).

6. The separator according to claim 1, wherein
the silicon-based negative electrode contains silicon monoxide (SiO), and
the positive electrode contains lithium (Li).

7. A non-aqueous electrolyte battery comprising:
the separator according to claim 1; and
the silicon-based negative electrode and the positive electrode separated by the separator.

8. The non-aqueous electrolyte battery according to claim 7, wherein the positive electrode is in contact with the second layer.

9. The non-aqueous electrolyte battery according to claim 7, wherein the separator includes a third layer that is interposed between the second layer and the positive electrode.
